(19) United States
(12) Patent Application Publication
(10) Pub. No.: US 2013/0050142 A1
(43) Pub. Date: Feb. 28, 2013

(54) ELECTRET INPUT DEVICE AND METHOD FOR OPERATING THE SAME

(71) Applicants: Cheng-Che TSAI, New Taipei (TW); Yu-Chi WANG, New Taipei (TW)

(72) Inventors: Cheng-Che TSAI, New Taipei (TW); Yu-Chi WANG, New Taipei (TW)

(73) Assignee: KYE SYSTEMS CORP., New Taipei (TW)

(21) Appl. No.: 13/571,519

(22) Filed: Aug. 10, 2012

(30) Foreign Application Priority Data
Aug. 26, 2011 (TW) 100130821

(51) Int. Cl. G06F 3/044

(52) U.S. Cl. 345/174

(57) ABSTRACT

A method for operating an electret input device includes the following steps. An input signal is received. It is determined whether a voltage level of the input signal is greater than a first preset value. If the voltage level is greater than the first preset value, the voltage level is compared with a second preset value to determine whether the input signal is an effective signal. If the input signal is the effective signal, the position value of the input signal is obtained. Then, the position value is compared with a preset position value to determine an input state of the electret input device. Finally, the input signal is converted to an output signal to be outputted.

### CROSS-REFERENCE TO RELATED APPLICATIONS

This non-provisional application claims priority under 35 U.S.C. §119(a) on Patent Application No(s). 100130821 filed in Taiwan, R.O.C. on Aug. 26, 2011, the entire contents of which are hereby incorporated by reference.

### BACKGROUND

1. Technical Field

The disclosure relates to an input device and a method for operating the input device, and more particularly to an electret input device which is capable of determining the input state and a method for operating the electret input device.

2. Related Art

Recently, touch panel technology advances rapidly so that touch devices are widely used in various electronic products. Generally, there are two kinds of touch panels, i.e., capacitance touch panel and resistance touch panel. Each kind of touch panels has its own merits and shortcomings. For example, the resistance touch panel is easily to be scratched. Moreover, it only can be sensed by a larger touch force and thus has low sensitivity. On the other hand, the capacitance touch panel has high sensitivity, but the manufacture process thereof is much complicated. Furthermore, the capacitance touch panel cannot sense a non-conductor such as touch pen, fingerstall, and etc.

However, there have been patent applications for protecting a touch device made of electret. For example, in the Taiwan patent application NO. 201044229, the electret touch device can sense a conductor (e.g., finger, probe) or nonconductor (e.g., touch pen, fingerstall). Moreover, no additional bias voltage is applied on the electret touch device and thus electricity power consumption can be saved.

Current touch keyboard, no matter capacitance touch keyboard or resistance touch keyboard, will output a corresponding operation signal when it is touched. That is, once a user touches the touch keyboard, a corresponding touch signal is generated and outputted to the subsequent devices without determining whether the input touch signal is an effective signal. In addition, the electret touch device in the above mentioned patent application does not determine whether the input touch signal is an effective signal or an ineffective signal generated by mistake. Therefore, when a user operates the current touch device, the user has to suspend hands to avoid an undesired operation caused by a careless touch of wrist or palm. In this case, the convenience for operating the touch panel is reduced.

### SUMMARY

In one aspect, a method for operating an electret input device is disclosed. The method comprises receiving an input signal, determining whether a voltage level of the input signal is greater than a first preset value, if it is determined that the voltage level is greater than the first preset value, comparing the voltage level with a second preset value to determine whether the input signal is an effective signal, if it is determined that the input signal is the effective signal, obtaining a position value of the input signal, comparing the position value with a preset position value to determine an input state of the electret input device, and converting the input signal to an output signal to be outputted.

In another aspect, an electret input device is disclosed. The electret input device comprises a touch unit, an amplifier, and a Micro Control Unit (MCU). The touch unit is used for generating an input signal according an input state of the electret input device. The amplifier is electrically connected to the touch unit and is used for receiving and amplifying the input signal. The MCU is electrically connected the amplifier circuit and is used for determining whether a voltage level of the input signal is greater than a first preset value. If it is determined that the voltage level is greater than the first preset value, the MCU compares the voltage level with a second preset value to determine whether the input signal is an effective signal. If it is determined that the input signal is the effective signal, the MCU obtains a position value of the input signal. The MCU compares the position value with a preset position value to determine an input state of the electret input device and converts the input signal to an output signal to be outputted.

### BRIEF DESCRIPTION OF THE DRAWINGS

The present disclosure will become more fully understood from the detailed description given herein below for illustration only, and thus are not limitative of the present disclosure, and wherein:

FIG. 1 is a block diagram of an electret input device according to an embodiment of the disclosure;

FIGS. 2A, 2B, 2C, and 2D show structure of the touch unit and different touch positions according to an embodiment of the disclosure;

FIG. 3 is a flowchart a method for operating an electret input device according to an embodiment of the disclosure; and

FIG. 4 is a detailed flowchart for the step S310 in FIG. 3.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The detailed characteristics and advantages of the disclosure are described in the following embodiments in details, the techniques of the disclosure can be easily understood and embodied by a person of average skill in the art, and the related objects and advantages of the disclosure can be easily understood by a person of average skill in the art by referring to the contents, the claims and the accompanying drawings disclosed in the specifications.

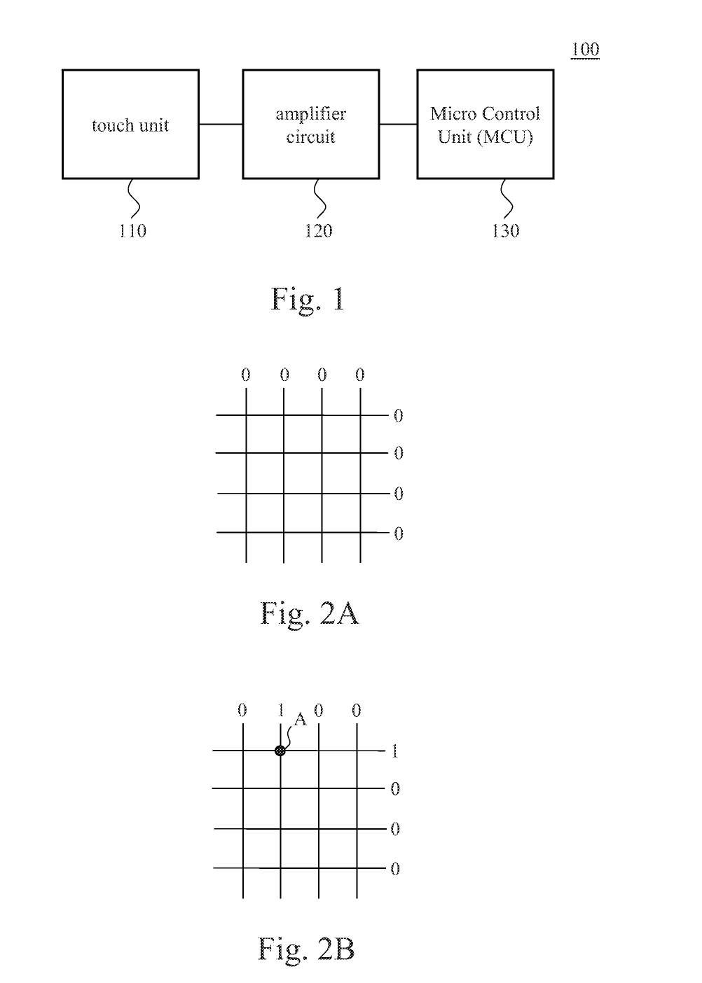

FIG. 1 shows a block diagram for an electret input device according to an embodiment of the disclosure. The electret input device 100 includes a touch unit 110, an amplifier circuit 120, and a Micro Control Unit (MCU) 130.

The touch unit 110 has multiple scan data lines which intersect at several points. These intersection points are touch points forming a touch area. The touch unit 110 generates an input signal according to a user's operation (for example, pressing or touching) on the electret input device 100. The amplifier circuit 120 electrically connected to the touch unit 110 is used to receive and amplify the input signal generated by the touch unit 110. The MCU 130 electrically connected to the amplifier circuit 120 is used to receive the amplified input signal and determine whether the input signal is an effective signal and the input state of the electret input device 100.

In this embodiment, the touch unit 110 may be an electret touch panel and the electret input device 100 may be an electret keyboard having the electret touch panel. The electret touch panel comprises a first electret film, a first electrode, a spacer, a second electrode, and a second electret film. When a user operates (presses or touches) the electret touch panel, the first electret film deforms to change the electrostatic field because of the touch or press from the external force. As a result, an input signal is generated. That is, the electrostatic field varies with different press forces. Thus, the voltage level of the input signal will vary with different press forces. In addition, the first electret film and the second electret film can be charged by a high-voltage corona method or a polarization method. Both the first and second electret films have a plurality of nano and micron holes and they can maintain at a high bias voltage after the charging process. Therefore, the electret touch panel unlike the capacitor touch device does not need to be applied an additional bias voltage.

Based on the above, when a user operates (presses or touches) the electret input device 100, the touch unit 110 will generate an input signal having electric charge because the electret film deforms by an external force to change the electrostatic field. In other words, the input signal has a voltage level. Furthermore, the input signal may have different voltage levels based on the different external forces (pressing by finger or touch by wrist) on the electret input device 100. For example, if a user uses a finger to press the electret input device 100, an input signal having the voltage level of approximately 0.5 mV is generated. If a user lays a wrist on the electret input device 100 (or touch the electret input device 100 by mistake), an input signal having the voltage level of approximately 0.1 mV is generated.

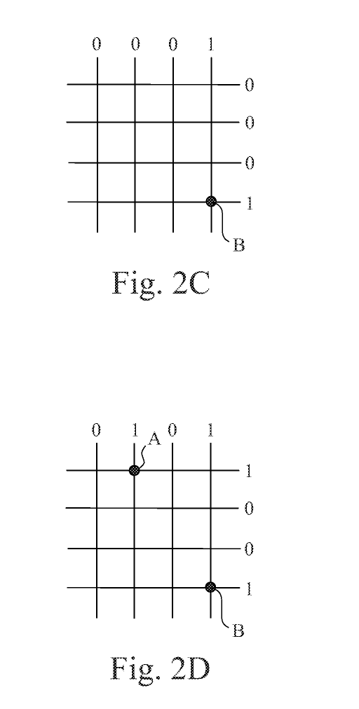

In addition, the input signal generated by the touch unit 110 further has a position value (X,Y) corresponding to the touch position. For easy illustration, suppose that the touch unit 110 has 4×4 scan data lines which intersect to form a touch area, as shown in FIG. 2A. When a user does not touch the electret input device 100, the position value for the input signal is for example (0000, 0000). When a user touches the position “A” as shown in FIG. 2B, the position value of the input signal is for example (0100, 1000). When a user touches the position “B” as shown in FIG. 2C, the position value of the input signal is for example (0001, 0001). When a user touches the positions “A” and “B” as shown in FIG. 2D, the position value of the input signal is for example (0101, 1001).

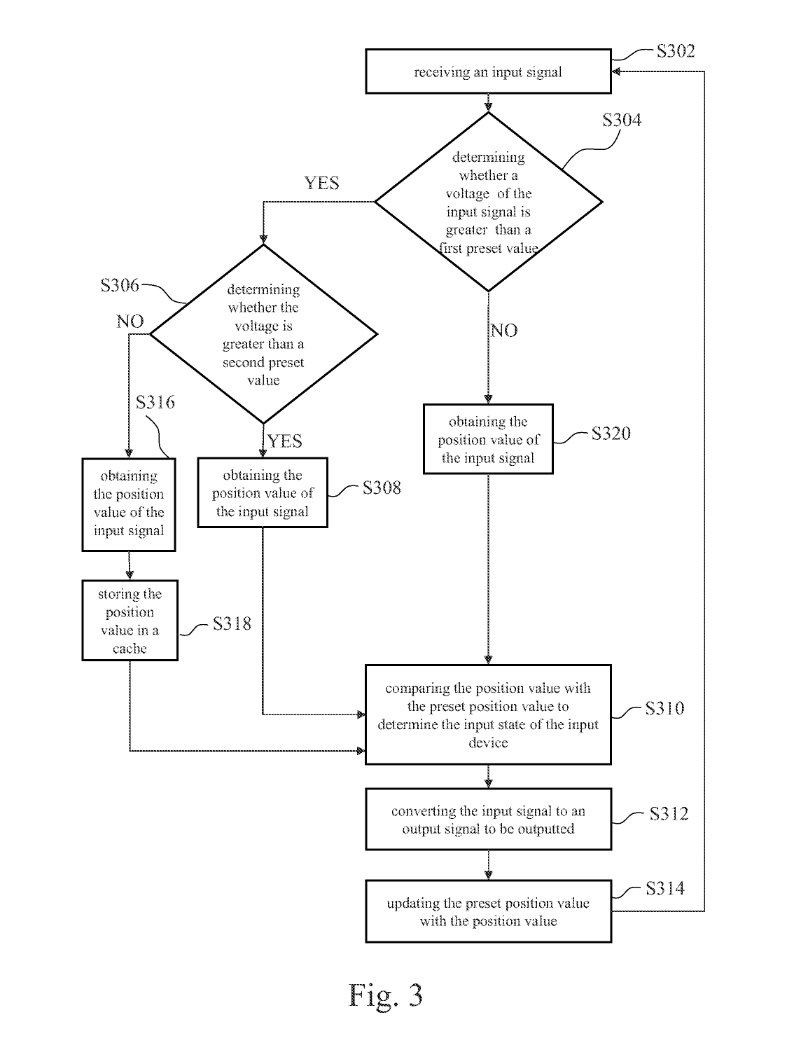

The following will explain in detail a method for operating the electret input device 100 with reference to the operation flowchart shown in FIG. 3.

FIG. 3 is a flowchart of a method for operating an electret input device according to an embodiment of the disclosure. In the step S302, an input signal is received. For example, the input signal is generated by the touch unit 110 according to the operation state of the electret input device 100. The input signal has a voltage level and a position value.

Next, in the step S304, it is determined that whether the voltage level of the input signal is greater than a first preset value. In this embodiment, the first preset value may be used to determine the operation state of the electret input device 100. That is, if the MCU 130 determines that the input signal is smaller than the first preset value, it means that no touch is on the electret input device 100, a user's finger or palm moves away from the electret input device 100, or a user continues pressing or touching the electret input device 100. If the controller 130 determines that the input signal is greater than the first preset value, it means that a user touches the electret input device by finger or wrist.

If it is determined that the voltage level of the input signal is greater than the first preset value, the method goes to the step S306. In the step S306, it is determined that whether the voltage level of the input signal is greater than a second preset value so as to determine whether the input signal is an effective signal. If it is determined that the voltage level of the input signal is greater than the second preset value, it means that the input signal is an effective signal and the method goes to the step S308 to obtain the position value of the input signal.

In the step S310, the position value is compared with a preset position value to determine the input state of the electret input device. The input state of the electret input device refers to for example that a user presses a new key, a user continues pressing a same key of the electret input device 100, or a user moves away a finger from the electret input device 100.

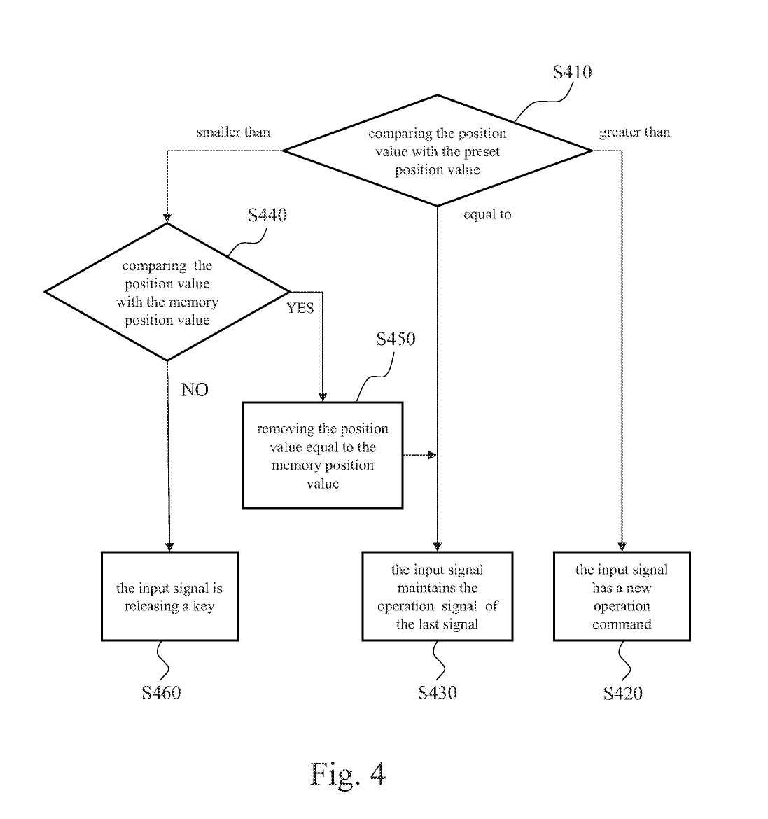

In particular, the step S310 further comprises the following steps, as shown in FIG. 4. In the step S410, the position value is compared with the preset position value. If the position value is greater than the preset position value, the method goes to the step S420. In the step S420, the MCU 130 obtains that the input signal has a new operation command, i.e., a user presses a new key. If the position value is equal to the preset position value, the method goes to the step S430. In the step S430, the MCU obtains that the input signal maintains the operation of the last input signal. That is, a user continues pressing a same key of the electret input device 100. If the position value is smaller than the preset position value, the method goes to the step S440. In the step S440, the MCU 130 compares the position value with a memory position value which for example is stored in a cache.

If the position value is equal to the memory position value, the method goes to the step S450. In the step S450, the MCU 130 removes the position value equal to the memory position value from the cache (i.e., the position value of the ineffective signal is removed). Thus, the MCU 130 obtains the position value of the last input signal. Next in the step S430, the MCU 130 obtains that the input signal maintains the operation command of the last input signal. On the other hand, if the position value is not equal to the memory position value, the method goes to the step S460. In the step S460, the MCU 130 obtains that the input signal is releasing the key. That is, a user moves away the finger from the electret input device 100. At this time, the input signal means that the user stops operating the electret input device 100 or that the electret input device 100 does not on operation.

Again with reference to FIG. 3, in the step S312, the input signal is converted to an output signal to be outputted. The output signal is outputted to the subsequent application devices. In the step S314, the position value is used to update the preset position value. Then, the method returns to the step S302 to perform the determination for the next input signal.

In addition, after the step S306, if it is determined that the voltage level of the input signal is smaller than the second preset value, it means that the input signal is not an effective signal and thus the method goes to the step S316. In the step S316, the position value of the input signal is obtained. Next in the step S318, the position value of the input signal (ineffective signal) is stored in the cache, and the position value is used as the memory position value.

In addition, after the step S304, if it is determined that the voltage level of the input signal is smaller than the first preset value, the method goes to the step S320. In the step S320, the position value of the input signal is obtained. Next, the steps S310, S312, and S314 are performed to finish the subsequent operations.

The following embodiment will illustrate in detail the operation flow of the electret input device 100.

Firstly, the preset position value in the MCU 130 is initialized as for example (0000, 0000). The first preset value may be for example 0.05 mV, and the second preset value may be for example 0.3 mV. When a user uses the finger to presses the position “A” as shown in FIG. 2B (step S302), the touch unit 110 generates an input signal with a voltage level for example 0.5 mV and a position value for example (0100, 1000). The MCU 130 determines that the voltage level of the input signal (0.5 mV) is greater than the first preset value (0.05 mV) (step S304), which means that the user operates (i.e., presses) the electret input device 100.

Then, the MCU 130 compares the voltage level of the input signal with the second preset value to determine whether the input signal is an effective signal (step S306). Since the voltage level of the input signal (0.5 mV) is greater than the second preset value (0.3 mV), the MCU 130 determines that the input signal is an effective signal and obtains the position value (0100, 1000) of the input signal (step S308). Next, the MCU 130 compares the position value (0100,1000) with the preset position value (0000, 0000) (step S410) to determine that the position value (0100, 1000) is greater than the preset position value (0000, 0000). The comparison result means that the input signal has a new operation command (step S420). The input signal is converted to be an output signal to be outputted to the subsequent application devices (step S312). Finally, the MCU 130 uses the position value (0100, 1000) to update the preset position value (step S314) so that the preset position value is changed to be (0100, 1000). The new preset position value will be used for the determination of the next input signal.

If the user continues pressing the position “A” as shown in FIG. 2B (step S302), the touch unit 110 (i.e., the electret touch panel) will not generate any electrostatic change (for example, the first electret film will not deform). As a result, the voltage level of the input signal is for example 0 mV. The MCU 130 determines that the voltage level of the input signal is smaller than the first preset value (0.05 mV) (step S304). Since the input signal is still at the original position (0100, 1000), the position value obtained by the MCU 130 is still (0100, 1000) (step S320). Then, the MCU 130 determines that the position value of the input signal (0100, 1000) is equal to the preset position value (0100, 1000) (step S410), and it means that the input signal maintains the operation of the last input signal (step S430). That is, the user continues pressing the same key of the electret input device 100. After that, the MCU 130 converts the input signal to the output signal to be outputted to the subsequent application devices (step S312). Then, the MCU 130 uses the position value (0100, 1000) to update the preset position value (step S314). In this case, the preset position value is still (0100, 1000).

After that, if the user releases the position “A” as shown in FIG. 2B (i.e., the user moves away the finger from the electret input device 100) (step S302), the voltage level of the input signal is for example 0 mV. The MCU 130 determines that the voltage level of the input signal is smaller than the first preset value (step S304). Since the user moves away the finger from the electret input device 100, the position value of the input signal obtained by the MCU 130 is (0000, 0000) (step S320). Then, the MCU 130 compares the position value (0000, 0000) with the preset position value (0100, 1000) and determines that the position value (0000, 0000) is smaller than the preset position value (0100, 1000) (step S410). After that, the MCU 130 determines that the position value (0000, 0000) is not equal to the memory position value (step S440). Thus, the MCU 130 determines that the position value (0000, 0000) is zero (step S450). It means that the input signal is releasing the key (step S460). That is, the user moves away the finger from the electret input device 100. Then, the MCU 130 converts the input signal to the output signal to be outputted to the subsequent application devices (step S312). Because the output signal does not have an operation command, the subsequent application devices will not perform corresponding operations. Then, the MCU 130 uses the position value (0000, 0000) to update the preset position value (step S314). In this case, the preset position value is changed to be (0000, 0000), which is used for the determination of the next input signal.

Furthermore, if a user presses the position “A” as shown in FIG. 2B and then presses the position “B” as shown in FIG. 2C, the electret film of the position B will deform by an external force. The voltage level of the input signal generated by the touch unit 110 is for example 0.5 mV and the position value of the input signal is for example (0101, 1001), as shown in FIG. 2D. Next, the MCU 130 determines that the voltage level (0.5 mV) of the input signal is greater than the first preset value (0.05 mV), which means that the user operates (presses) the electret input device 100 (step S304).

Then, the MCU 130 compares the voltage of the input signal (0.5 mV) with the second preset value (0.3 mV) to determine whether the input signal is an effective signal (step S306). Since the voltage level of the input signal (0.5 mV) is greater than the second preset value (0.3 mV) (step S306), the MCU 130 will determine that the input signal is an effective signal and obtain the position value of the input signal (0101, 1001). Next, the MCU 130 compares the position value (0101, 1001) with the preset position value (0100, 1000) (step S410) to determine that the position value (0101, 1001) is greater than the preset position value (0100, 1000). It means that the input signal has a new operation command (step S420). Then, the MCU 130 converts the input signal to the output signal to be outputted to the subsequent application devices (step S312). Finally, the MCU 130 uses the position value (0101, 1001) to update the preset position value (step S314). In this case, the preset position value is changed to be (0101, 1001) for the determination of the next input signal. Therefore, the electret input device 100 has a function for multi-point touch.

Furthermore, if the user uses a finger to press the position “A” as shown in FIG. 2B and puts the wrist at the position “B” as shown in FIG. 2C, the electret film at the position “B” will deform due to an external force. The voltage level of the input signal generated by the touch unit 110 is for example 0.1 mV and the position value of the input signal is for example (0101, 1001), as shown in FIG. 2D. Then, the MCU 130 determines that the voltage level of the input signal (0.1 mV) is greater than the first preset value (0.05 mV) (step S304). It means that the user operates (i.e., presses) the electret input device 100.

Then, the MCU 130 compares the voltage level of the input signal (0.1 mV) with the second preset value (0.3 mV) to determine whether the input signal is an effective signal (step S306). Since the voltage level of the input signal (0.1 mV) is smaller than the second preset value (0.3 mV), the MCU 130 determines that the input signal is not an effective signal and obtains the position value (0001, 0001) of the input signal (i.e., the ineffective signal) (step S316). Actually, the position value is for the touch position “B”.

Because the input signal is an ineffective signal, the MCU 130 stores the position value (0001, 0001) of the effective signal (i.e., the position value for the position “B”) in a cache (step S318) as a memory position value. Then, the MCU 130 compares the position value (0001, 0001) with the preset position value (0100, 1000) (step S410) to determine that the position value (0001, 0001) is smaller than the preset position value (0100, 1000). Next, in the step S440, the MCU 130 compares the position value (0001, 0001) with the memory position value to find that the position value is equal to the memory position value. Thus, the MCU 130 removes the position value (0001, 0001) equal to the memory position value (0001, 0001) from the cache. Because the position value (0001, 0001) of the ineffective signal is removed, the MCU 130 obtains the position value (0100, 1000) of the last input signal. That is, the input signal maintains the operation of the last input signal (step S430). Then, the MCU 130 converts the input signal to the output signal to be outputted to the subsequent application devices (step S312). Finally, the MCU 130 uses the position value (0100, 1000) to update the preset position value (step S314). As a result, the preset position value is changed to be (0100, 1000) for the determination of the next input signal.

Accordingly, the embodiment can determine whether an input signal is an effective signal to avoid the undesired impact caused by error touch on the electret input device 100 or putting the wrist on the electret input device 100. Therefore, the convenience for operating the electret input device 100 is improved.

Based on the above, the method for operating an electret input device according to an embodiment of the disclosure uses the voltage level of an input signal to determine whether the input signal is an effective signal to avoid the undesired impact caused by error touch on the electret input device or putting the wrist on the electret input device. In addition, the input state of the input device can be determined by the position value of the input signal. For example, the input state refers to pressing a new key, releasing a key, and maintaining the command of the last input signal. The current input state is further used to adjust the preset position value for the determination of the next input signal. As a result, a user may comfortably operate the electret input device. Even if a wrist is put on the electret device within the touch area, an error operation will not be caused. Therefore, the convenience for operating the electret input device can be improved.

Note that the specifications relating to the above embodiments should be construed as exemplary rather than as limitative of the present invention, with many variations and modifications being readily attainable by a person skilled in the art without departing from the spirit or scope thereof as defined by the appended claims and their legal equivalents.

What is claimed is:

1. A method for operating an electret input device, comprising:
receiving an input signal;
determining whether a voltage level of the input signal is greater than a first preset value;
if it is determined that the voltage level is greater than the first preset value, comparing the voltage level with a second preset value to determine whether the input signal is an effective signal;
if it is determined that the input signal is the effective signal, obtaining a position value of the input signal;
comparing the position value with a preset position value to determine an input state of the electret input device; and
converting the input signal to an output signal to be outputted.

2. The method according to claim 1, after the step of converting the input signal to an output signal to be outputted, the method further comprising:
updating the preset position value with the position value and returning to the step of receiving the input signal.

3. The method according to claim 1, wherein the step of comparing the position value with the preset position value to determine the input state of the electret input device comprises:
comparing the position value and the preset position value;
if the position value is equal to the preset position value, the input signal maintains an operation command of the last input signal;
if the position value is greater than the preset position value, the input signal has a new operation command;
if the position value is smaller than the preset position value, comparing the position value with a memory position value in a cache;
if the position value is not equal to the memory position value, the input signal is releasing a key; and
if the position value is equal to the memory position value, the position value equal to the memory position value is removed from the cache, and the input signal maintains the operation command of the last input signal.

4. The method according to claim 3, wherein the step of determining whether the input signal is the effective signal further comprises:
if it is determined that the input signal is not the effective signal, obtaining the position value of the input signal; and
storing the position value of the input signal in the cache as the memory position value, and going to the step of comparing the position value with the preset position value to determine the input state of the electret input device.

5. The method according to claim 3, after the step of determining whether the voltage level of the input signal is greater than the first preset value, the method further comprises:
if it is determined that the voltage level of the input signal is smaller than the first preset value, obtaining the position value of the input signal and going to the step of comparing the position value with the preset position value to determine the input state of the electret input device.

6. An electret input device, comprising:
a touch unit for generating an input signal according an input state of the electret input device;
an amplifier circuit electrically connected to the touch unit for receiving and amplifying the input signal; and
a Micro Control Unit (MCU) electrically connected the amplifier circuit for receiving the amplified input signal and determining whether a voltage level of the input signal is greater than a first preset value, if it is determined that the voltage level is greater than the first preset value, the MCU compares the voltage level with a second preset value to determine whether the input signal is an effective signal, if it is determined that the input signal is the effective signal, the MCU obtains a position value of the input signal, and the MCU compares the position value with a preset position value to determine an input state of the electret input device and converts the input signal to an output signal to be outputted.

7. The electret input device according to claim 6, wherein the MCU uses the position value to update the preset position value.

8. The electret input device according to claim 6, wherein if the MCU determines that the position value is equal to the preset position value, the input signal maintains an operation command of the last input signal, if the MCU determines that the position value is greater than the preset position value, the input signal has a new operation command, if the MCU determines that the position value is smaller than the preset position value, the MCU compares the position value with a memory position value in a cache, and if the position value is not equal to the memory position value, the input signal is releasing a key, if the MCU determines that the position value is equal to the memory position value, the position value equal to the memory position value is removed from the cache and the input signal maintains the operation command of the last input signal.

9. The electret input device according to claim 8, wherein if the MCU determines that the input signal is not the effective signal, obtaining the position value of the input signal and storing the position value of the input signal in the cache as the memory position value.

10. The electret input device according to claim 8, wherein if the MCU determines that the voltage level of the input signal is smaller than the first preset value, obtaining the position value of the input signal.
